(19) United States
(12) Patent Application Publication
(10) Pub. No.: US 2024/0081412 A1
(43) Pub. Date: Mar. 14, 2024

(54) An Aerosol Generating Device and an Aerosol Generating System

(71) Applicant: JT International SA, Geneva (CH)

(72) Inventors: Erik Snijder, Enschede (NL); Jeroen Dammers, Zwolle (NL)

(73) Assignee: JT International SA, Geneva (CH)

(21) Appl. No.: 18/273,900

(22) PCT Filed: Jan. 26, 2022
(86) PCT No.: PCT/EP2022/051719

§ 371 Date: Jul. 24, 2023

(30) Foreign Application Priority Data
Feb. 2, 2021 (EP) 21154689.0

(51) Int. Cl. A24F 40/465; A24F 40/20; A24F 40/48; A24F 40/70; H05B 6/10

(52) U.S. Cl. CPC A24F 40/465; A24F 40/20; A24F 40/48; A24F 40/70; H05B 6/105

(57) ABSTRACT

An aerosol generating device includes a heating chamber for receiving an aerosol generating article and at least one inductively heatable susceptor mounted in the heating chamber such that there is an outer air gap between the susceptor and the chamber wall and, when an aerosol generating article is received in the heating chamber, there is an inner air gap between the susceptor and the aerosol generating article. When a user inhales through the aerosol generating article, incoming air flows through the inner and outer air gaps, absorbing heat from inner and outer surfaces of the susceptor, which results in efficient pre-heating of the air drawn into the aerosol generating article.

### TECHNICAL FIELD

The present disclosure relates generally to an aerosol generating device, and more particularly to an aerosol generating device for heating an aerosol generating substrate to generate an aerosol for inhalation by a user. Embodiments of the present disclosure also relate to an aerosol generating system comprising an aerosol generating device and an aerosol generating substrate. The present disclosure is particularly applicable to a portable (hand-held) aerosol generating device. Such devices heat, rather than burn, an aerosol generating substrate, e.g., tobacco or other suitable materials, by conduction, convention, and/or radiation to generate an aerosol for inhalation by a user.

### TECHNICAL BACKGROUND

The popularity and use of reduced-risk or modified-risk devices (also known as aerosol generating devices or vapour generating devices) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device. In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

Currently available aerosol generating devices can use a number of different approaches to provide heat to the aerosol generating substrate. One such approach is to provide an aerosol generating device which employs an induction heating system. In such a device, an induction coil is provided in the device and an inductively heatable susceptor is provided to heat the aerosol generating substrate. When a user activates the device, electrical energy is supplied to the induction coil, which generates an alternating electromagnetic field. The susceptor couples with the electromagnetic field to induce local eddy currents and/or larger scale circulating currents to flow in the susceptor. The flow of currents in the susceptor generates resistive heating. Depending on the material of the susceptor, it may also undergo heating by magnetic hysteresis. Heat is transferred from the susceptor to the aerosol generating substrate, for example by thermal conduction, and an aerosol is generated as the aerosol generating substrate is heated.

It is generally desirable to heat an aerosol generating substrate rapidly, in order to attain and maintain a sufficiently high temperature in the aerosol generating substrate to generate a vapour. The present disclosure seeks to provide an aerosol generating device that rapidly heats an aerosol generating substrate to a desired temperature, while at the same time maximising the energy efficiency of the device.

### SUMMARY OF THE DISCLOSURE

According to a first aspect of the present disclosure, there is provided an aerosol generating device comprising: a heating chamber for receiving an aerosol generating article, the heating chamber comprising a chamber wall that defines an interior volume of the heating chamber; and at least one inductively heatable susceptor mounted in the interior volume of the heating chamber such that there is an outer air gap between the susceptor and the chamber wall and, when an aerosol generating article is received in the heating chamber, there is an inner air gap between the susceptor and the aerosol generating article. The heating chamber is open to the atmosphere at a proximal end and closed at a distal end, the inner air gap providing a first air path from the proximal end to the distal end and the outer air gap providing a second air path from the proximal end to the distal end.

The inner air gap reduces thermal conduction between the susceptor and the aerosol generating article, while the outer air gap reduces thermal conduction between the susceptor and the chamber wall. Providing air gaps adjacent to both the inner and outer surfaces of the susceptor results in efficient transfer of heat from the susceptor to the surrounding air.

The device may be configured so that, when an aerosol generating article is received in the heating chamber, no part of the susceptor is in contact with the aerosol generating article. This reduces the risk of burning the wrapper or substrate of the aerosol generating article by direct conduction of heat from the susceptor. Instead, by pre-heating the air that flows through the aerosol generating article, heat is distributed more uniformly through the aerosol generating substrate.

The device may comprise a plurality of susceptors disposed circumferentially around an axis of the heating chamber. A plurality of susceptors may facilitate the manufacture or assembly of the device and, if the susceptors are electrically isolated from each other, this may prevent the circulation of induced currents continuously around the device.

Each susceptor may be in the form of a plate curved in an arc about the axis. Such plates are easy to manufacture and may be combined to form a segmented cylindrical surface, which is uniformly spaced from both the chamber wall and the aerosol generating article.

The device may comprise a frame received in the heating chamber, the frame not being inductively heatable, and the at least one susceptor being mounted in the frame. This provides a convenient way of manufacturing the device. The frame can also be configured to be removable from the heating chamber, for example to permit cleaning or replacement of the susceptors.

The frame may comprise guides for centering the aerosol generating article in the heating chamber. This ensures the desired spacing to form the inner air gap between the susceptors and the aerosol generating article. The frame may thereby also help to retain the aerosol generating article in the device.

The frame may comprise a seat for a distal end of the aerosol generating article. This can maintain an air gap between the distal end of the aerosol generating article and a base of the heating chamber to ensure that air can flow from the heating chamber into the distal end of the aerosol generating article.

Such a device may be used in a method comprising: inserting at least part of an aerosol generating article into the heating chamber; and drawing air through the aerosol generating article away from the distal end of the heating chamber, thereby causing incoming air to flow along the first air path and the second air path towards the distal end of the heating chamber. At the same time, the at least one susceptor may be inductively heated to increase the temperature of the incoming air as it flows past the susceptor along the first air path and along the second air path.

Air in the first air path flows over an inner surface of the susceptor and air in the second air path flows over an outer surface of the susceptor. Providing airflow over both the inner and outer surfaces of the susceptor results in efficient transfer of heat from the susceptor to raise the temperature of the air drawn through the aerosol generating article.

According to another aspect of the present disclosure, an aerosol generating device may comprise a heating chamber for receiving an aerosol generating article, the heating chamber comprising a chamber wall that defines an interior volume of the heating chamber; and a method of assembling the aerosol generating device may comprise: mounting one or more inductively heatable susceptors in a frame; and inserting the frame and the one or more susceptors into the heating chamber such that there is an outer air gap between each of the one or more susceptors and the chamber wall and, when an aerosol generating article is received in the heating chamber, there is an inner air gap between the susceptor and the aerosol generating article.

The susceptors preferably comprise a material that is electrically conductive and magnetically permeable, preferably a metallic material. If the susceptors are formed of such a material, they will be capable of undergoing inductive heating. The metallic material is typically selected from the group consisting of stainless steel and carbon steel. The inductively heatable susceptor could, however, comprise any suitable material including one or more, but not limited, of aluminium, iron, nickel, stainless steel, carbon steel, and alloys thereof, e.g. nickel chromium or nickel copper.

The aerosol generating device may include a power source and controller, e.g., comprising control circuitry, which may be configured to operate at a high frequency. The power source and circuitry may be configured to operate at a frequency of between approximately 70 kHz and 1 MHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The aerosol generating substrate may comprise any type of solid or semi-solid material. Example types of aerosol generating solids include powder, granules, pellets, shreds, strands, particles, gel, strips, loose leaves, cut filler, porous material, foam material or sheets. The aerosol generating substrate may comprise plant derived material and in particular, may comprise tobacco. It may advantageously comprise reconstituted tobacco, for example including tobacco and any one or more of cellulose fibres, tobacco stalk fibres and inorganic fillers such as CaCO₃.

Consequently, the aerosol generating device may be referred to as a “heated tobacco device”, a “heat-not-burn tobacco device”, a “device for vaporising tobacco products”, and the like, with this being interpreted as a device suitable for achieving these effects. The features disclosed herein are equally applicable to devices which are designed to vaporise any aerosol generating substrate.

The aerosol generating substrate may form part of an aerosol generating article and may be circumscribed by a paper wrapper. When the aerosol generating substrate is received in the heating chamber of the aerosol generating device, other parts of the aerosol generating article may remain outside the heating chamber to provide, for example, a mouthpiece for the user.

The aerosol generating article may be formed substantially in the shape of a stick, and may broadly resemble a cigarette, having a tubular region with an aerosol generating substrate arranged in a suitable manner. The aerosol generating article may include a filter segment, for example comprising cellulose acetate fibres, at a proximal end of the aerosol generating article. The filter segment may constitute a mouthpiece filter and may be in coaxial alignment with the aerosol generating substrate. One or more vapour collection regions, cooling regions, and other structures may also be included in some designs. For example, the aerosol generating article may include at least one tubular segment upstream of the filter segment. The tubular segment may act as a vapour cooling region. The vapour cooling region may advantageously allow the heated vapour generated by heating the aerosol generating substrate to cool and condense to form an aerosol with suitable characteristics for inhalation by a user, for example through the filter segment.

The aerosol generating substrate may comprise an aerosol former. Examples of aerosol formers include polyhydric alcohols and mixtures thereof such as glycerine or propylene glycol. Typically, the aerosol generating substrate may comprise an aerosol former content of between approximately 5% and approximately 50% on a dry weight basis. In some embodiments, the aerosol generating substrate may comprise an aerosol former content of between approximately 10% and approximately 20% on a dry weight basis, and possibly approximately 15% on a dry weight basis.

Upon heating, the aerosol generating substrate may release volatile compounds. The volatile compounds may include nicotine or flavour compounds such as tobacco flavouring.

### BRIEF DESCRIPTION OF THE DRAWINGS

FIG. 1 is a diagrammatic longitudinal cross-sectional view of an aerosol generating system comprising an aerosol generating device and an aerosol generating article ready to be positioned in a heating chamber of the aerosol generating device, which is useful for understanding the present invention;

FIG. 2 is a diagrammatic longitudinal cross-sectional view of the aerosol generating system of FIG. 1, showing the aerosol generating article positioned in the heating chamber of the aerosol generating device;

FIG. 3 is a further diagrammatic longitudinal cross-sectional view, showing the airflow through a heating chamber of an aerosol generating device in accordance with the present invention;

FIGS. 4 and 5 are diagrammatic transverse cross-sectional views, showing two examples of susceptor configuration in accordance with the present invention;

FIG. 6 is a perspective view of a first embodiment of susceptor frame in accordance with the present invention;

FIG. 7 is a partially exploded perspective view of the susceptor frame of FIG. 6;

FIG. 8 is a perspective view of a second embodiment of susceptor frame in accordance with the present invention; and

FIG. 9 is an exploded perspective view of the susceptor frame of FIG. 8.

### DETAILED DESCRIPTION OF THE DRAWINGS

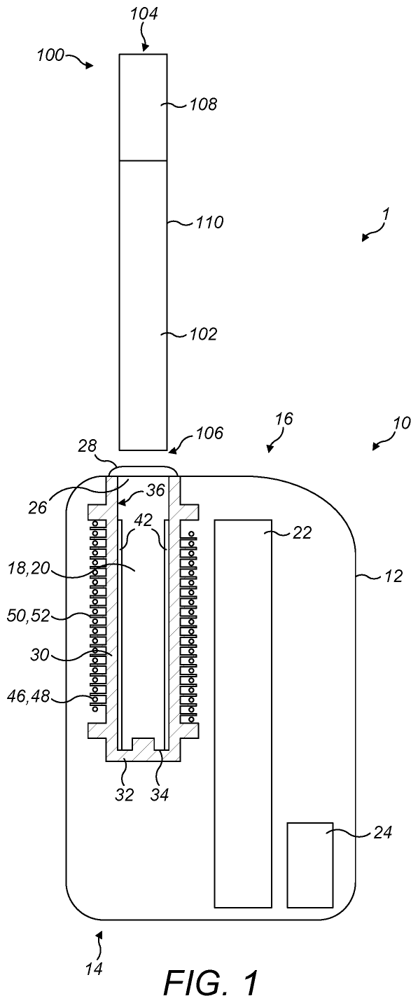

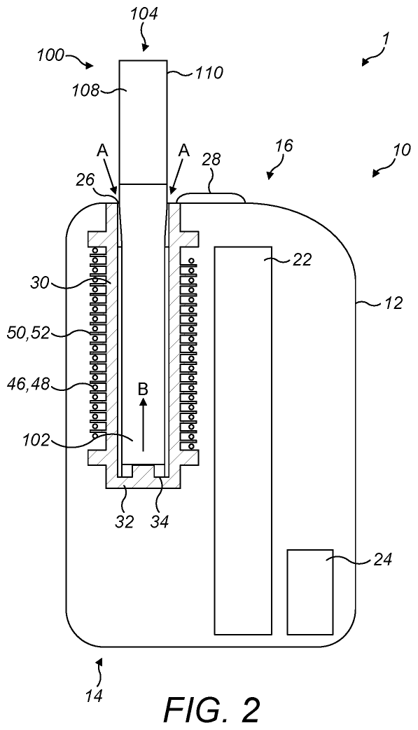

Referring initially to FIGS. 1 and 2, there is shown diagrammatically an example of an aerosol generating system 1. The aerosol generating system 1 comprises an aerosol generating device 10 and an aerosol generating article 100 for use with the device 10.

The aerosol generating device 10 comprises a main body 12 housing various components of the aerosol generating device 10. The main body 12 can have any shape that is sized to fit the components described in the various embodiments set out herein and to be comfortably held by a user unaided, in a single hand.

A first end 14 of the aerosol generating device 10, shown towards the bottom of FIGS. 1 and 2, is described for convenience as a distal, bottom, base or lower end of the aerosol generating device 10. A second end 16 of the aerosol generating device 10, shown towards the top of FIGS. 1 and 2, is described as a proximal, top or upper end of the aerosol generating device 10. During use, the user typically orients the aerosol generating device 10 with the first end 14 downward and/or in a distal position with respect to the user's mouth and the second end 16 upward and/or in a proximal position with respect to the user's mouth.

The aerosol generating device 10 comprises a heating chamber 18 positioned in the main body 12. The heating chamber 18 defines an interior volume in the form of a cavity 20 having a substantially circular cross-section for receiving at least part of a substantially cylindrical aerosol generating article 100. The heating chamber 18 has a longitudinal axis defining a longitudinal direction. A proximal end 26 of the heating chamber 18 is open towards the second end 16 of the aerosol generating device 10. The heating chamber 18 is typically held spaced apart from the inner surface of the main body 12 to minimise heat transfer to the main body 12.

The aerosol generating device 10 further comprises a power source 22, for example one or more batteries which may be rechargeable, and a controller 24.

The aerosol generating device 10 can optionally include a sliding cover 28 movable transversely between a closed position (see FIG. 1) in which it covers the open end 26 of the heating chamber 18 to prevent access to the heating chamber 18 and an open position (see FIG. 2) in which it exposes the open first end 26 of the heating chamber 18 to provide access to the heating chamber 18. The sliding cover 28 can be biased to the closed position in some embodiments.

The heating chamber 18, and specifically the cavity 20, is arranged to receive a correspondingly shaped generally cylindrical or rod-shaped aerosol generating article 100. The aerosol generating article 100 typically comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The aerosol generating article 100 further comprises a mouthpiece segment 108 positioned downstream of the aerosol generating substrate 102. The aerosol generating substrate 102 and the mouthpiece segment 108 are arranged in coaxial alignment inside a wrapper 110 (e.g., a paper wrapper) to hold the components in position to form the rod-shaped aerosol generating article 100.

The mouthpiece segment 108 can comprise one or more of the following components (not shown in detail) arranged sequentially and in co-axial alignment in a downstream direction, in other words from the distal end 106 towards the proximal (mouth) end 104 of the aerosol generating article 100: a cooling segment, a centre hole segment and a filter segment. The cooling segment typically comprises a hollow paper tube having a thickness which is greater than the thickness of the wrapper 110. The centre hole segment may comprise a cured mixture containing cellulose acetate fibres and a plasticizer, and functions to increase the strength of the mouthpiece segment 108. The filter segment typically comprises cellulose acetate fibres and acts as a mouthpiece filter. As heated vapour flows from the aerosol generating substrate 102 towards the proximal (mouth) end 104 of the aerosol generating article 100, the vapour cools and condenses as it passes through the cooling segment and the centre hole segment to form an aerosol with suitable characteristics for inhalation by a user through the filter segment.

The heating chamber 18 has a side wall (or chamber wall) 30 extending between a base 32, located at a distal end 34 of the heating chamber 18, and the open end 26. The chamber wall 30 and the base 32 are connected to each another and can be integrally formed as a single piece. In the illustrated embodiment, the chamber wall 30 is tubular and, more specifically, cylindrical. In other embodiments, the chamber wall 30 can have other suitable shapes, such as a tube with an elliptical or polygonal cross section. In yet further embodiments, the chamber wall 30 can be tapered. The chamber wall 30 and the base 32 are formed of a heat-resistant plastics material, such as polyether ether ketone (PEEK).

In the illustrated embodiment, the base 32 of the heating chamber 18 is closed, e.g. sealed or air-tight. That is, the heating chamber 18 is cup-shaped. This can ensure that air drawn from the open end 26 is prevented by the base 32 from flowing out of the second end 34 and is instead guided through the aerosol generating substrate 102. It can also ensure that a user inserts the aerosol generating article 100 into the heating chamber 18 an intended distance and no further.

The aerosol generating device 10 comprises at least one inductively heatable susceptor 42. It may comprise a plurality of the inductively heatable susceptors 42 circumferentially spaced around the heating chamber 18. The inductively heatable susceptors 42 may be elongate in the longitudinal direction of the heating chamber 18.

The aerosol generating device 10 comprises an electromagnetic field generator 46 for generating an electromagnetic field. The electromagnetic field generator 46 comprises a substantially helical induction coil 48. The induction coil 48 has a circular cross-section and extends helically around the substantially cylindrical heating chamber 18. The induction coil 48 can be energised by the power source 22 and controller 24. The controller 24 includes, amongst other electronic components, an inverter which is arranged to convert a direct current from the power source 22 into an alternating high-frequency current for the induction coil 48.

The chamber wall 30 of the heating chamber 18 includes a coil support structure 50 formed in the outer surface 38. In the illustrated example, the coil support structure 50 comprises a coil support groove 52, which extends helically around the outer surface 38. The induction coil 48 is positioned in the coil support groove 52 and is, thus, securely and optimally positioned with respect to the inductively heatable susceptors 42.

In order to use the aerosol generating device 10, a user displaces the sliding cover 28 (if present) from the closed position shown in FIG. 1 to the open position shown in FIG. 2. The user then inserts an aerosol generating article 100 through the open end 26 of the heating chamber 18, so that the aerosol generating substrate 102 is received in the cavity 20 and at least part of the mouthpiece segment 108 projects from the open end 26 to permit engagement by a user's lips.

Upon activation of the aerosol generating device 10 by a user, the induction coil 48 is energised by the power source 22 and controller 24 which supply an alternating electrical current to the induction coil 48, and an alternating and time-varying electromagnetic field is thereby produced by the induction coil 48. This couples with the inductively heatable susceptors 42 and generates eddy currents and/or magnetic hysteresis losses in the susceptors 42 causing them to heat up. Heat is then transferred from the inductively heatable susceptors 42 to the aerosol generating substrate 102, for example by conduction, radiation or convection. This results in heating of the aerosol generating substrate 102 without combustion or burning, and a vapour is thereby generated. The generated vapour cools and condenses to form an aerosol which can be inhaled by a user of the aerosol generating device 10 through the mouthpiece segment 108, and more particularly through the filter segment.

The vaporisation of the aerosol generating substrate 102 is facilitated by the addition of air from the surrounding environment, for example through the open end 26 of the heating chamber 18, the air being heated as it flows between the aerosol generating article 100 and the inner surface 36 of the chamber wall 30. More particularly, when a user sucks on the filter segment, air is drawn into the heating chamber 18 through the open end 26 as illustrated by the arrows A in FIG. 2. The air entering the heating chamber 18 flows from the open end 26 towards the closed end 34, between the aerosol generating article 100 and the chamber wall 30. When the air reaches the closed end 34 of the heating chamber 18, it turns through approximately 170° and enters the distal end 106 of the aerosol generating article 100. The air is then drawn through the aerosol generating article 100, as illustrated by the arrow B in FIG. 2, from the distal end 106 towards the proximal (mouth) end 104 along with vapour generated from the substrate 102.

A user can continue to inhale aerosol all the time that the aerosol generating substrate 102 is able to continue to produce a vapour, e.g. all the time that the aerosol generating substrate 102 has vaporisable components left to vaporise into a suitable vapour. The controller 24 can adjust the magnitude of the alternating electrical current passed through the induction coil 48 to ensure that the temperature of the inductively heatable susceptors 42, and in turn the temperature of the aerosol generating substrate 102, does not exceed a threshold level. Specifically, at a particular temperature, which depends on the constitution of the aerosol generating substrate 102, the aerosol generating substrate 102 will begin to burn. This is not a desirable effect and temperatures above and at this temperature are avoided. The material from which the chamber wall 30 and the base 32 are formed is chosen to be able to resist being heated repeatedly to temperatures up to the threshold during the expected lifetime of the aerosol generating device.

To assist with temperature regulation, in some examples the aerosol generating device 10 is provided with a temperature sensor (not illustrated). The controller 24 is arranged to receive an indication of the temperature of the aerosol generating substrate 102 from the temperature sensor and to use the temperature indication to control the magnitude of the alternating electrical current supplied to the induction coil 48. Means such as pressure or flow sensors (not illustrated) may be provided to detect airflow through the heating chamber 18 and to energise the induction coil 48 only when the user is actively inhaling through the device 10.

A single inhalation by a user is generally referred to a “puff”. In some scenarios, it is desirable to emulate a cigarette smoking experience, which means that the aerosol generating device 10 is typically capable of holding sufficient aerosol generating substrate 102 to provide ten to fifteen puffs.

In line with emulating the experience of cigarette smoking, the power source 22 is usually sufficient to repeat this cycle (bringing the aerosol generating substrate 102 up to the desired temperature and maintaining that temperature and vapour generation for ten to fifteen puffs) ten times, or even twenty times, thereby emulating a user's experience of smoking a packet of cigarettes, before there is a need to replace or recharge the power source 22.

In general, the efficiency of the aerosol generating device 10 is improved when as much as possible of the heat that is generated by the inductively heatable susceptors 42 results in heating of the aerosol generating substrate 102. To this end, the aerosol generating device 10 is usually configured to provide heat in a controlled manner to the aerosol generating substrate 102 while reducing heat loss to other parts of the aerosol generating device 10. In particular, heat flow to parts of the aerosol generating device 10 that the user handles is kept to a minimum, thereby keeping these parts cool and comfortable to hold.

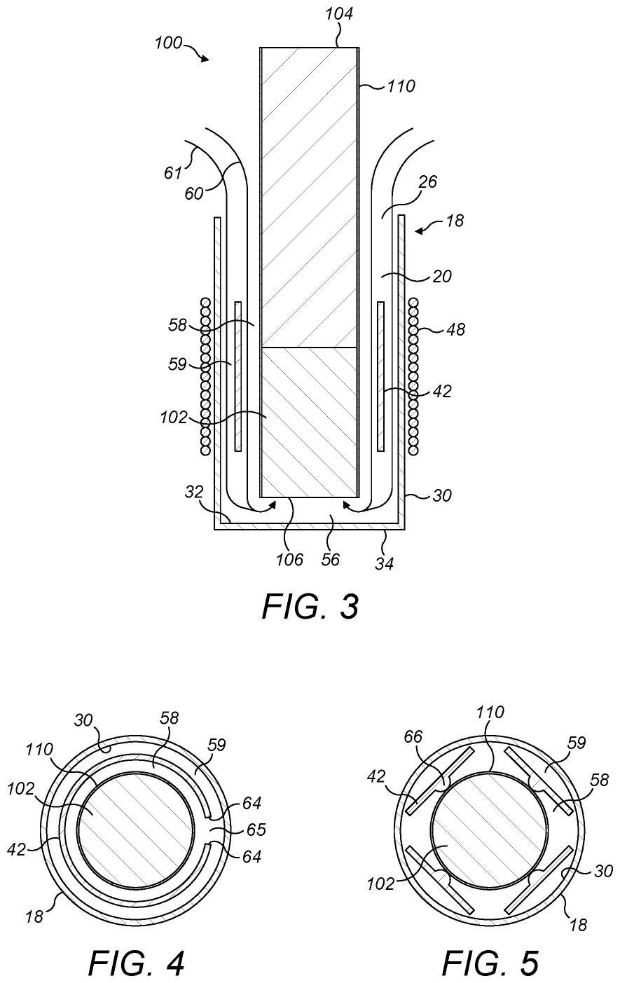

FIG. 3 illustrates a pattern of airflow through a heating chamber 18 of an aerosol generating device 10. The heating chamber 18 is cup-shaped, having a closed distal end 34 and an open proximal end 26. The generally cylindrical chamber wall 30 is surrounded by an induction coil 48. A aerosol generating article 100 is received in the heating chamber 18 such that the aerosol generating substrate 102 is fully within the chamber 18 but the proximal end 104 of the aerosol generating article 100 remains outside the heating chamber 18. The distal end 106 of the aerosol generating article 100 is not advanced fully to the base 32 of the chamber 18, in order that there should remain a gap 56, through which air can enter the distal end 106 of the aerosol generating article 100 from the heating chamber 18.

One or more susceptors 42 are disposed circumferentially around the interior volume 20 of the heating chamber 18. The susceptors 42 are axially aligned with the induction coil 48. Each susceptor 42 is radially positioned such that there is an inner air gap 58 between the susceptor 42 and the wrapper 110 of the aerosol generating article 100 and an outer air gap 59 between the susceptor 42 and the chamber wall 30. When a user inhales through the aerosol generating article 100, air is drawn out of the distal end of the heating chamber 18, reducing the pressure there. This causes atmospheric air to flow in from the proximal end 26 of the heating chamber to equalise the pressure. The inner air gap 58 between the susceptors 42 and the aerosol generating article 100 provides a first path 60 for air to flow from the proximal end 26 to the distal end 34 of the heating chamber 18. The outer air gap 59 between the susceptors 42 and the chamber wall 30 provides a second path 61 for air to flow from the proximal end 26 to the distal end 34 of the heating chamber 18. Air flowing along the first air path 60 passes over an inner surface of the susceptor 42 and air flowing along the second air path 61 passes over an outer surface of the susceptor 42. Air flowing along both paths 60,61 therefore remains close to the susceptor 42 over a significant distance, during which heat is transferred from the susceptor 42 to the air. Providing airflow over both the inner and outer surfaces of the susceptor 42 results in efficient heat transfer. The air is accordingly pre-heated to a high temperature before entering the distal end 106 of the aerosol generating article 100. The hot air is then distributed through all parts of the aerosol generating substrate 102, whereas heat that may be transferred from the susceptors 42 by conduction or radiation will have a greater effect at the radially outer parts of the substrate 102 and may risk burning the substrate 102 or the wrapper 110 of the aerosol generating article 100.

FIG. 4 shows a first example of a possible susceptor configuration in the device of FIG. 3, seen in transverse cross section. The device comprises a single susceptor 42, in the form of a plate or sheet that is curved in an arc about the axis of the heating chamber 18 to form a C-shape or an almost complete cylinder. Opposite edges 64 of the plate are spaced slightly apart from one another to leave a small circumferential gap 65. As already seen in FIG. 3, the susceptor 42 is radially positioned such that there is an inner air gap 58 between the susceptor 42 and the wrapper 110 of the aerosol generating article 100 and an outer air gap 59 between the susceptor 42 and the chamber wall 30. No part of the susceptor 42 is in contact with the aerosol generating article 100 so there is a reduced risk that the wrapper 110 or the substrate 102 of the aerosol generating article 100 may be burned through the excessive conduction of heat.

The circumferential gap 65 in the susceptor 42 may be beneficial if it is not desired that currents induced in the susceptor 42 should be able to circulate continuously around its circumference. The gap 65 may also facilitate assembly of the device, as described below. It will readily be understood that additional gaps 65 could be provided, thereby dividing the plate into two, three, four or more discrete, arcuate susceptors 42 that together form a segmented cylinder. It will also be readily understood that a single susceptor 42 could be formed without any gap 65, as a continuous cylinder.

This generally cylindrical form of the susceptor 42 or the plurality of susceptors 42 may have advantages. First, the susceptors 42 are at a uniform distance from the induction coil 48 so would be expected to heat up uniformly. Secondly, the susceptors 42 are also at a uniform distance from the aerosol generating article 100 so would be expected to radiate heat to the aerosol generating substrate 102 uniformly around its circumference. Thirdly, the inner and outer air gaps 58,59 have a uniform cross section around their circumference so the flow of air along the first and second air paths 60,61 may be smoother or more uniform. However, such a susceptor 42 has the disadvantage that, as it does not contact the aerosol generating article 100, alternative means (not shown in FIG. 3) must be provided to support the aerosol generating article 100 in the device.

FIG. 5 shows an alternative example of a possible susceptor configuration in the device of FIG. 3, seen in transverse cross section. In this example there are four susceptors 42 distributed around the circumference of the heating chamber 18. Each susceptor 42 comprises a flat plate that is generally tangential to the surface of the aerosol generating article 100. A rib 66 projects radially inwards from the centre of each susceptor plate 42 and contacts the wrapper 110 of the aerosol generating article 100 along a narrow line. The ribs 66 of the four susceptors 42 thus support the aerosol generating article 100 between them. The ribs 66 may be formed as beads on the susceptor plates 42, as shown, or they may be formed by deforming the susceptor plates. The ribs 66 serve to minimise the area of contact between the susceptors 42 and the aerosol generating article 100 but they could alternatively be omitted so that the aerosol generating article 100 is instead supported by direct tangential contact with the inner surfaces of flat susceptor plates 42. It will readily be understood that in alternative examples the number of susceptors 42 could be more or less than four.

The configuration of susceptors 42 seen in FIG. 5 provides inner air gaps 58 between the susceptors 42 and the wrapper 110 of the aerosol generating article 100 and an outer air gaps 59 between the susceptors 42 and the chamber wall 30. Thereby air flowing along the first and second air paths 60,61 through the heating chamber 18 passes over the inner and outer surfaces of the susceptors 42 to be heated before it enters the distal end 106 of the aerosol generating article 100.

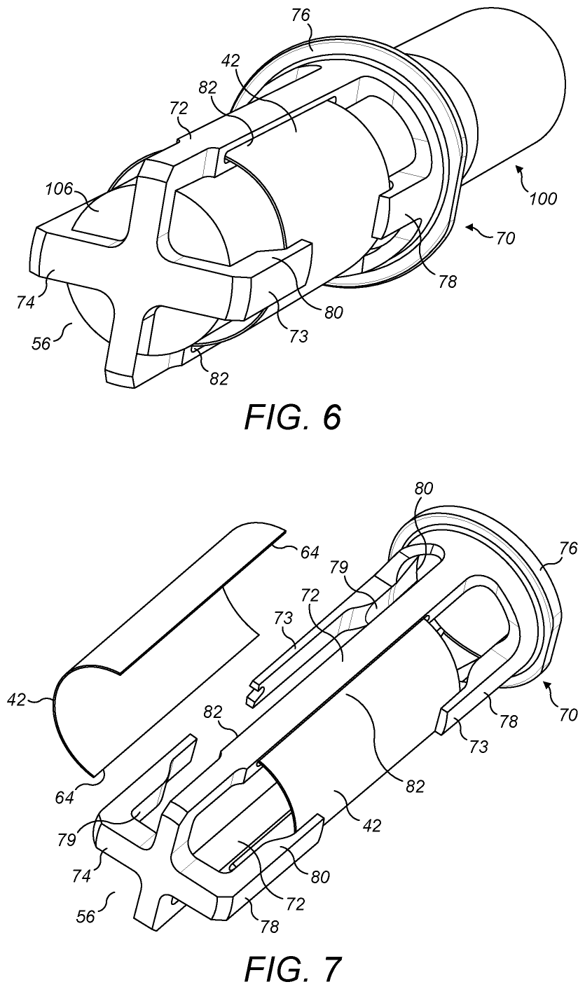

FIGS. 6 and 7 illustrate a susceptor assembly according to a first embodiment of the present invention. This embodiment comprises two susceptors 42, each having an almost semi-circular cross section, so that together they form a cylinder with two opposing gaps. The susceptors 42 are mounted in a frame 70, which holds them in the desired relationship to one another and to the other components of the vapour generating system. The frame 70 is formed from a material such as PEEK, in which no significant currents are induced by the operation of the induction coil 48.

The frame 70 comprises a generally cup-shaped cage, having a number of longitudinal struts 72,73 that are joined by a base 74 at the distal end and by a collar 76 at the proximal end. The struts 72,73 have outer surfaces 78 at a radius such that the frame 70 fits closely inside the heating chamber 18 (not seen in FIGS. 6 and 7). The collar 76 may have a larger radius to abut the rim of the open end 26 of the heating chamber 18. The collar 76 may be used to withdraw the frame 70 and susceptors 42 from the heating chamber 18, for example for cleaning or replacement. The struts 72,73 have inner surfaces 79 at a radius such that they support the aerosol generating article 100 within the heating chamber 18. Proximal ends of the inner surfaces 79 may be provided with ramps 80 to guide the aerosol generating article 100 into position and to compress it slightly as it is pushed in the distal direction, whereby the aerosol generating article 100 is held securely in the device 10 by the inner surfaces 79. The distal end of the aerosol generating article 100 is stopped by the base 74 of the frame 70 before it reaches the base 32 of the heating chamber 18. The base 74 thereby forms a seat for the aerosol generating article 100, while defining air gaps 56 through which air can flow from the heating chamber 18 into the aerosol generating article 100.

Two opposing struts 72 are used to mount the susceptors 42. Each of them comprises a pair of back-to-back, circumferentially facing, blind slots 82. Each slot 82 receives a longitudinal edge 64 of one of the susceptors 42. Intermediate struts 73 support the susceptors 42 to hold them in the slots 82. The slots are formed in the frame 70 at a radius such that, when the frame 70 is inserted into the heating chamber 18 of the device 10, there is an outer air gap 59 between the susceptor 42 and the chamber wall 30; and such that, when a aerosol generating article 100 is inserted into the frame 70, there is an inner air gap 58 between the susceptor 42 and the aerosol generating article 100.

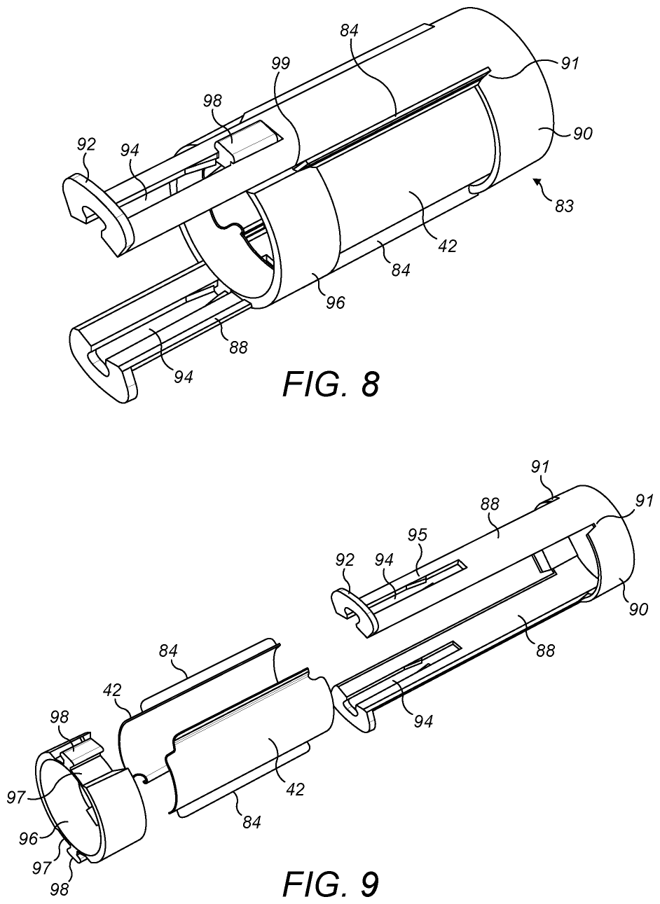

FIGS. 8 and 9 illustrate a susceptor assembly 83 according to a second embodiment of the present invention. This embodiment also comprises two susceptors 42, each having the general form of an arcuate plate that forms a segment of a cylinder centred on the axis of the device 10, but in this case the gaps between the susceptors 42 are larger than in FIGS. 6 and 7. The longitudinal edges of the susceptors are turned outwards to form flanges 84.

The frame 86 of this embodiment comprises a pair of longitudinal struts 88, the distal ends of which are connected to one another by a ring 90. Notches 91 are formed in a proximal edge of the ring 90, adjacent to the struts 88. The proximal end of each strut 88 is turned outwards to form a flange 92. A longitudinal slot 94 is formed in each strut 88 and extends to the proximal end of the strut 88. Part of the way along each slot 94 is a retaining feature 95, where the slot 94 is slightly narrowed. A separate collar 96 includes two outwardly facing recesses 97. In each recess 97 is a projection 98 that extends radially outwards and has a T-shaped profile.

The components are assembled as shown in FIG. 8 to form the susceptor assembly 83. Each susceptor 42 slides between a pair of the struts 88 until the distal ends of the susceptor flanges 84 locate in the notches 91 of the ring 90. The collar 96 then slides in the distal direction so that the projections 98 of the collar 96 engage and travel along the longitudinal slots 94 of the struts 88. At the ends of the slots 94, the projections 98 snap fit behind the retaining features 95 to retain the collar 96 in the frame 86. Further notches 99 are created where the struts 88 adjoin the recesses 97 of the collar 96 and the proximal ends of the susceptor flanges 84 locate in those notches 99 to secure the susceptors 42 in position.

The flanges 92 at the proximal ends of the struts 88 may be used to insert the susceptor assembly 83 into the heating chamber 18 of a vapour generating device 10, or subsequently to remove the susceptor assembly, e.g. for cleaning or replacement. When the susceptor assembly 83 is positioned in the heating chamber 18, the out-turned susceptor flanges 84 maintain an outer air gap 59 between the cylindrical outer surface of each susceptor 42 and the chamber wall 30. The radius of the inner surfaces of the susceptors 42 is greater than the radius of the aerosol generating article 100 for use with the device 10, whereby an inner air gap 58 is maintained between each susceptor 42 and the aerosol generating article 100. The illustrated susceptor assembly 83 does not provide any means for locating the aerosol generating article 100, although the collar 96 and the ring 90 could easily be adapted to guide it into position. The ring 90 also does not provide any end stop for the aerosol generating article 100 to ensure that there is a gap 56 for air to flow into its distal end 106. However, the base 32 of the heating chamber 18 itself may be formed to provide such a feature, as seen in FIG. 2, for example.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating device comprising:
a heating chamber for receiving an aerosol generating article, the heating chamber comprising a chamber wall that defines an interior volume of the heating chamber; and
at least one inductively heatable susceptor mounted in the interior volume of the heating chamber such that there is an outer air gap between the at least one inductively heatable susceptor and the chamber wall is received in the heating chamber, there is an inner air gap between the at least one inductively heatable susceptor and the aerosol generating article;
wherein the heating chamber is open to the atmosphere at a proximal end and is closed at a distal end, the inner air gap providing a first air path from the proximal end to the distal end and the outer air gap providing a second air path from the proximal end to the distal end.

2. The aerosol generating device according to claim 1, wherein, when an aerosol generating article is received in the heating chamber, no part of the at least one inductively heatable susceptor is in contact with the aerosol generating article.

3. The aerosol generating device according to claim 1, wherein the at least one inductively heatable susceptor comprises a plurality of susceptors spaced circumferentially around an axis of the heating chamber.

4. The aerosol generating device according to claim 3, wherein each of the plurality of susceptors is in the form of a plate curved in an arc about the axis.

5. The aerosol generating device according to claim 1, further comprising a frame received in the heating chamber, the frame not being inductively heatable, and the at least one inductively heatable susceptor being mounted in the frame.

6. The aerosol generating device according to claim 5, wherein the frame comprises guides for centering an aerosol generating article in the heating chamber.

7. The aerosol generating device according to claim 5, wherein the frame comprises a seat for a distal end of an aerosol generating article.

8. A method of using the aerosol generating device according to claim 1, comprising:
inserting at least part of an aerosol generating article into the heating chamber; and
drawing air through the aerosol generating article away from the distal end of the heating chamber, thereby causing incoming air to flow along the first air path and the second air path towards the distal end of the heating chamber.

9. The method according to claim 8, further comprising inductively heating the at least one inductively heatable susceptor to increase a temperature of incoming air as the air flows past the at least one inductively heatable susceptor along the first air path and along the second air path.

10. A method of assembling an aerosol generating device;
the device comprising a heating chamber for receiving an aerosol generating article, the heating chamber comprising a chamber wall that defines an interior volume of the heating chamber, the heating chamber being open to the atmosphere at a proximal end and closed at a distal end;
the method comprising:
mounting one or more inductively heatable susceptors in a frame; and
inserting the frame and the one or more inductively heatable susceptors into the heating chamber such that there is an outer air gap between each of the one or more inductively heatable susceptors and the chamber wall and, when an aerosol generating article is received in the heating chamber, there is an inner air gap between the one or more inductively heatable susceptors and the aerosol generating article, whereby the inner air gap provides a first air path from the proximal end to the distal end and the outer air gap provides a second air path from the proximal end to the distal end.
